(19) United States
(12) Patent Application Publication
(10) Pub. No.: US 2008/0246342 A1
(43) Pub. Date: Oct. 9, 2008

(54) Electrical Switching Device Arrangement

(75) Inventor: Stephanie Anter, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/090,420

(22) PCT Filed: Oct. 17, 2006
(86) PCT No.: PCT/EP2006/067501

§ 371 Date: Apr. 16, 2008

(30) Foreign Application Priority Data
Oct. 18, 2005 (DE) 10 2005 050 694.1

(51) Int. Cl. H01B 7/04

(52) U.S. Cl. 307/113

(57) ABSTRACT

An electric switching device arrangement has a switching section consisting of at least one first and one second switching point which are electrically connected in series by a conductor section used therefor. In order to compensate external vibrations effecting the electric switching device arrangement provided with the switching section, the conductor section consists of at least two bend slackening conductor elements which are connected to each other by way of a rigid connecting element. The elongated length of the conductor elements is greater than a distance along a straight line between contact points of the switching points.

The invention relates to an electrical switching device arrangement having a switching section which has at least one first and one second switching point, which are electrically connected in series with one another by means of a conductor section.

An electrical switching device arrangement such as this is described, for example, in the book “Schaltgerate Grundlagen, Aufbau, Wirkungsweise”, [Principles of Switching Devices, Design Method of Operation], published by Manfred Lindmayer, Springer-Verlag Berlin, Heidelberg, New York, London, Paris, Tokyo 1987, on pages 208 to 210. The switching device arrangement there has four switching sections, two of which are each supported by a separate supporting insulator. Two switching sections which are supported by different supporting insulators have mutually facing ends. In order to connect the mutually facing switching sections in series, they are electrically conductively connected by means of a conductor section.

During use of the electrical switching device arrangement, external influences, for example wind, earthquakes, or else switching processes themselves, lead for example to oscillations of the electrical switching device arrangement. The previously used connection of the switching points restricts the capability of the electrical switching device arrangement to oscillate.

The object of the invention is therefore to develop an electrical switching device arrangement of the type mentioned initially such that the switch arrangement can oscillate better.

In the case of an electrical switching device arrangement of the type mentioned initially, the object is achieved according to the invention in that the conductor section has at least one first and one second very flexible conductor element, each of whose ends are attached to contact-making points of the first and of the second switching point, with the stretched length of the conductor elements being greater than a distance which runs along a straight line between the contact-making points, and with a rigid connection element connecting the flexible conductor elements to one another.

The use of very flexible conductor elements, for example of a cable or a chain composed of links of electrically conductive material, such as copper, makes it possible to easily compensate for relative oscillation of the first and second switching sections of the electrical switching device arrangement with respect to one another. The choice of increased stretched length reduces the mechanical load on the very flexible conductor elements, thus ensuring a permanent electrically conductive connection. The use of the rigid connection element for the flexible conductor elements allows the movement of the conductor elements with respect to one another to be restricted. This restricts the flexibility of the individual conductor elements themselves, since they are supported with respect to one another via the connection element.

In this case, it is advantageously possible to provide for the rigid connection element to be supported by the very flexible conductor elements.

The use of the very flexible conductor elements as supporting elements for the rigid connection element means that there is no need to install additional holding apparatuses. This would represent an additional load on the electrical switching device arrangement. The this case, it is particularly advantageous for the rigid connection element to be supported exclusively by the very flexible conductor elements. Projections and edges on electrical switching device arrangements are dielectrically shielded by field control elements. The connection element and the conductor elements may be located entirely within the area of protection of the previously used field control elements.

A further advantageous development makes it possible to provide for the rigid connection element to guide the very flexible conductor elements parallel to one another.

Parallel guidance of a plurality of conductor elements results in the conductor elements being stabilized with respect to one another. On the basis of the parallel mounting of the conductor elements on the connection element itself, the very flexible conductor elements can be continued in different directions from the attachment points to the rigid connection element. This makes it possible to produce further arrangements which reinforce the stability of the conductor sections with respect to one another.

In this case, it is also advantageously possible to provide for the conductor elements each to be bent through more than 45°, in particular through 90°, starting from the parallel guidance on the connection element, towards the contact-making points.

After emerging from the rigid connection element, the very flexible conductor elements are still aligned parallel to one another, at least immediately after leaving the rigid connection element. Obtuse-angled bending allows the conductor elements to run along a three-dimensional path which has at least one elongated curvature. The curvature results in compensation areas, which make it possible to compensate for any relative movement between the first and the second switching point.

In this case, the conductor elements may be shaped such that they are arranged laid on a path on one plane. However, they may also be laid with bends of angles through more than 45°, and in particular through 90°.

A further advantageous development makes it possible to provide for the connection element to fix the very flexible conductor elements on a plane with respect to one another.

The arrangement of the very flexible conductor elements on a plane on the connection element makes it possible to support bulging or bending in a specific direction in the event of the position of the switching points changing with respect to one another. A plurality of conductor elements are therefore arranged such that they lie flat alongside one another. This results in a flat ribbon arrangement. It is therefore possible to assist preferred deflection movements.

A further advantageous development makes it possible to provide for at least one very flexible conductor element to be guided in a U-shape.

A U-shaped position can be produced by using the force of gravity when choosing suitable contact-making points with appropriate feeding of the ends of the very flexible conductor elements to the contact-making points. The rigid connection element can then be mounted in a simple manner in the bottom area of the U. In this case, it is either possible to provide for a very flexible conductor element to pass completely through the rigid connection element, or for the rigid connection element to be used as a stop for the very flexible conductor elements, with a U-shaped or else some other laid shape being produced only on attachment of a plurality of conductor elements. The use of a continuous very flexible conductor element has the advantage that there is no need for additional contact points, which would increase the electrical impedance. The rigid connection element can electrically isolate the plurality of very flexible conductor elements from one another, or else can electrically conductively connect them. The use of a plurality of conductor elements which allow connection of the contact-making points only after they have been coupled via the rigid connection element has an advantage because it is possible to use short sections of conductor elements which can be combined as required and can make contact with one another via the rigid connection element. This simplifies assembly.

A further advantageous development makes it possible to provide for at least one very flexible conductor element to be guided in an S-shape.

S-shaped guidance of one of the very flexible conductor elements represents a further suitable shape to positively influence the oscillation behavior of an electrical switching device arrangement. It is particularly advantageous for a plurality of very flexible conductor elements to be formed in an S-shape and to be guided in opposite senses with respect to one another. On a lateral projection, because of the rigid coupling via the connection element, this results in the conductor section connecting the two switching points having a cruciform shape. A shape such as this is able to reliably absorb oscillation movements acting in different directions. By way of example, a cruciform shape such as this can also be achieved by arranging two U-shaped very flexible conductor elements with U-shapes pointing in opposite directions, and by coupling them by means of a rigid connection element.

A further advantageous development makes it possible to provide for the very flexible conductor elements to be guided in the same way and to be arranged such that they are located one behind the other, covering one another, on a projection.

An arrangement covering one another makes it possible to use a multiplicity of identical very flexible conductor elements. The physical space required is reduced by an arrangement such as this. The arrangement of a plurality of conductor elements one behind the other and covering one another in a viewing direction results in the conductor section formed from a plurality of very flexible conductor elements having a structure like a flat ribbon.

It is advantageously also possible to provide for the very flexible conductor elements to be arranged with mirror-image symmetry with respect to one another on a projection.

An arrangement with mirror-image symmetry makes it possible when using identical conductor elements and when they are laid in an identical manner, for example in a U-shape or in an S-shape, to produce additionally stabilizing shapes of the conductor section. Zones which intersect one another, for example, on the projection allow very flexible conductor elements to be used with a particularly long extended length in order to ensure that the electrical switching device arrangement can oscillate well. Despite the long extended lengths, the conductor section has adequate mechanical stability because of a rigid connection element, thus preventing uncoordinated oscillation or swinging of the very flexible conductor elements which form a part of the conductor section.

Exemplary embodiments of the invention will be described in more detail in the following text and are illustrated schematically in a drawing, in which:

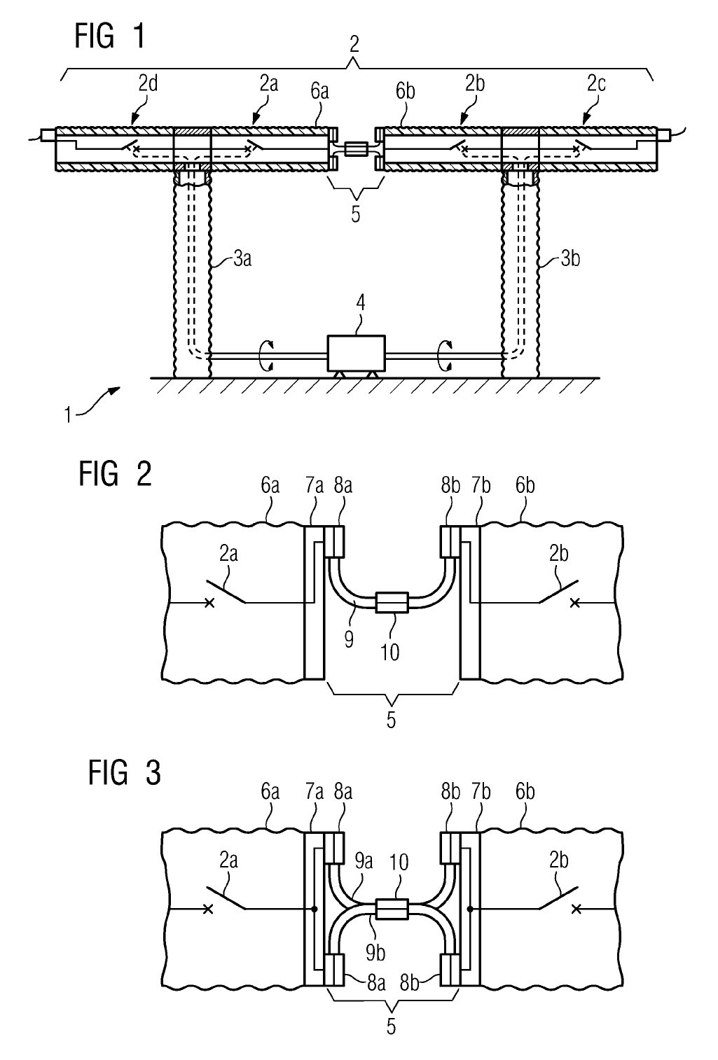

FIG. 1 shows a side view of an electrical switching device arrangement with a conductor section;

FIG. 2 shows a detail of a first variant of a development of the conductor section;

FIG. 3 shows a second variant of a conductor section;

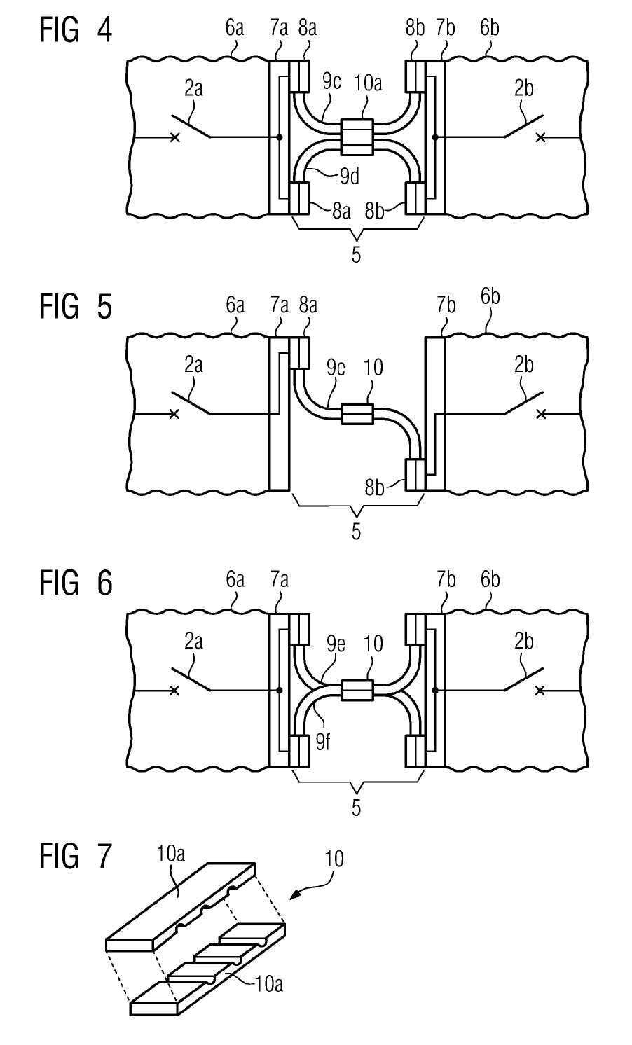

FIG. 4 shows a third variant of a conductor section;

FIG. 5 shows a fourth variant of a conductor section;

FIG. 6 shows a fifth variant of a conductor section; and

FIG. 7 shows a rigid connection element.

FIG. 1 shows a side view of an electrical switching device arrangement 1, partially cut away. The electrical switching device arrangement 1 has a switching section 2 which is formed from a first switching point 2a, a second switching point 2b, a third switching point 2c and a fourth switching point 2d. The switching points 2a, 2b, 2c, 2d are electrically connected in series with one another. This is advantageous particularly for high and very high voltages, for example for voltages of more than 480 kV, in order to ensure that the switching section 2 has an adequate withstand voltage.

Two of the switching points 2a, 2d; 2b, 2c are respectively supported by a supporting insulator 3a, 3b. The switching points 2a, 2b, 2c, 2d are operated by a common drive device 4. Any movement produced by the drive device 4 is transmitted within the supporting insulators 3a, 3b to the movable contact elements of the switching points 2a, 2b, 2c, 2d.

The switching points 2a, 2b, 2c, 2d are each arranged within encapsulating housings 6a, 6b. The encapsulating housings 6a, 6b are manufactured in the present exemplary embodiment from insulating material, so that the electrical switching device arrangement 1 is a so-called live-tank switch. The interior of the encapsulation housings 6a, 6b is in each case filled with a pressurized insulating gas, for example sulfurhexafluoride, nitrogen or mixtures of gases such as these. The mutually facing ends of the first and second switching points 2a, 2b are electrically conductively connected to one another by means of a conductor section 5. Connection options for electrical power transmission devices, such as lines or cables, are in each case arranged at the mutually averted ends of the third and fourth switching points 2c, 2d.

FIGS. 2, 3, 4, 5 and 6 illustrate the various development variants of the conductor section 5.

FIGS. 2, 3, 4, 5 and 6 each show the mutually facing ends of the first and second switching points 2a, 2b. The encapsulating housings 6a, 6b which surround the switching points 2a, 2b are essentially designed to be hollow and cylindrical, and are closed in a gas-tight manner at the end faces of the fitting bodies 7a, 7b. The fitting bodies 7a, 7b are manufactured from an electrically conductive material and are part of the current path which can be switched by means of the switching section 2. The fitting bodies 7a, 7b which are associated with the respective housings 6a, 6b are electrically conductively connected to the respective first and second switching points 2a, 2b. The fitting bodies 7a, 7b have respective connecting terminals 8a, 8b. The connecting terminals 8a, 8b are each formed from half-shells, between which an electrical conductor can be clamped in by the application of external clamping forces, and can have electrical contact made with it. Clamping-in holders for the connecting terminals 8a, 8b have an essentially cylindrical shape, into which a conductor element provided with a cylindrical external contour can be inserted. The connecting terminals 8a, 8b represent contact-making points. The position of the clamping-in holders in the connecting terminals 8a, 8b is chosen such that their axial alignment, which is governed by the cylindrical shape, is arranged transversely with respect to an axis running between the first and the second switching point to 2a, 2b. A first very flexible conductor element 9 is inserted into and braced in the fitting bodies 8a, 8b. The very flexible conductor element 9 is in the form of an electrically conductive cable, with the ends of the conductor element 9 each being inserted from the same direction into the clamping-in holders of the connecting terminals 8a, 8b. In consequence, the very flexible conductor element 9 is U-shaped.

A rigid connection element 10 is arranged in the central area of the very flexible conductor element 9. The rigid connection element 10 is used to couple a plurality of very flexible conductor elements which are located one behind the other, covering one another, in the present exemplary embodiment, and are arranged identically, at a rigid angle.

By way of example, FIG. 7 shows a rigid connection element 10. The rigid connection element 10 has a first half-shell 10a and a second half-shell 10b, which can be pressed onto one another. In the contact area between two surfaces of the half-shells 10a, 10b, cylindrical recesses are formed, into which very flexible conductor elements can be inserted, so that they are guided parallel in the area of the rigid connection element 10. The sizes of the recesses are in this case chosen such that the very flexible conductor elements are braced in the rigid connection element 10 so the two half-shells 10a, 10b are pressed together. In the present example, the rigid connection element 10 which is illustrated in FIG. 7 is used to couple three very flexible conductor elements.

The rigid connection element 10 may be designed such that it allows electrical contact to be made with the very flexible conductor elements 9 which have been inserted into the recesses. However, it can also be designed so as to allow the very flexible conductor elements 9, which are jointly surrounded by the rigid connection element 10, to be held in an insulated manner. Depending on the currents to be transmitted, the number of very flexible conductor elements 9 which are braced in one rigid connection element 10 may vary. The number can be matched appropriately to the recess for holding the very flexible conductor elements 9.

Since the first and the second switching point 2a, 2b, as well as the encapsulating housings 6a, 6b, the fitting bodies 7a, 7b and the connecting terminals 8a, 8b are in each case of identical design, only the conductor sections 5, which are designed differently to one another, would in each case be explained in the description of the following embodiment variants.

FIG. 3 shows a conductor section 5 designed such that a first very flexible conductor element 9a is laid in a U-shape, and a second very flexible conductor element 9b is likewise laid in a U-shape. However, the two very flexible conductor elements 9a, 9b are arranged with mirror-image symmetry with respect to one another, with the mirror-image axis being arranged parallel to an axis which extends between the switching points 2a, 2b. A known form of connecting terminals 8a, 8b is in each case provided for attachment of the first and of the second respective very flexible conductor elements 9a, 9b, with the connecting terminals 8a, 8b associated with the first very flexible conductor element 9a in each case holding the very flexible conductor element 9a, coming from the same direction. The connecting terminals 8a, 8b which are associated with the second very flexible conductor element 9b hold the ends of the second very flexible conductor element 9b, likewise from the same direction, with this running in the opposite direction sense with respect to the insertion direction of the first very flexible conductor element 9a to its associated connecting terminals 8a, 8b (with mirror-image symmetry). A rigid connection element 10 is once again provided in the central area of the first and of the second very flexible conductor element 9a, 9b and connects a plurality of conductor elements, in the present case two conductor elements, to one another at a rigid angle, one behind the other with respect to the plane of the drawing. On the projection, this therefore results in a cruciform conductor section 5 which is formed from intrinsically very flexible conductor elements and, as a result of being clamped in at the connecting terminals 8a, 8b and as a result of the rigid connection element 10 and the way in which the very flexible conductor elements 9a, 9b are laid, this represents a comparatively rigid structure, but which can compensate for oscillations.

The first and the second very flexible conductor elements 9a, 9b are guided approximately parallel to one another on a plane on the rigid connection element 10. The first and the second very flexible conductor elements 9a, 9b are also guided approximately parallel in the immediate inlet and outlet area of the rigid connection element 10. After emerging from the rigid connection element 10, the very flexible conductor elements 9a, 9b are each bent through 90°, with the conductor elements 9a, 9b each being bent in the same direction, therefore in each case resulting in a U-shaped profile. However, it is also possible to use other angles which are in each case greater than 45°. The individual sections of the very flexible conductor elements can also be deflected such that the conductor elements 9 can emerge from a plane as well, and can extend into a space.

FIG. 4 shows an alternative to the exemplary embodiment of a conductor section 5 illustrated in FIG. 3. The conductor section 5 is once again formed from a plurality of very flexible conductor elements 9c, 9d. However, one development variant of a rigid connection element 10 is designed such that, on the projection shown in FIG. 4, there is no overlap between the laying paths of the very flexible conductor elements 9c, 9d, although they are designed with mirror-image symmetry. When using exclusively two very flexible conductor elements 9c, 9d these also lie on one and the same plane. However, if provision is made for further very flexible conductor elements to be located, covering one another, behind the very flexible conductor elements 9c, 9d which can be seen in FIG. 4, then the conductor elements run on two planes in the area of the rigid connection element 10a, with the planes being aligned approximately parallel, but at a distance from one another.

FIG. 5 shows a further development variant of a conductor section 5, in which a further very flexible conductor element 9e is laid in an S-shape. For this purpose, the connecting terminals 8a, 8b are separated from one another such that the further very flexible conductor element 9e is in each case introduced into the connecting terminals 8a, 8b from opposite directions. A plurality of further very flexible conductor elements 9e which are arranged located one behind the other, covering one another, are coupled to one another by a rigid connection element 10.

FIG. 6 shows a development variant of the conductor section 5 illustrated in FIG. 5. A further very flexible conductor element 9e and a very flexible conductor element 9f are each bent in an S-shape and have an identical bent shape, but the deflection directions of the S-curves are aligned in opposite senses (with mirror-image symmetry), thus resulting in the conductor elements 9e, 9f crossing over on a projection illustrated in FIG. 6. These elements are stabilized in the central area of a rigid connection element 10. This once again results in a cruciform connection being formed between the contacts of the first and of the second switching point 2a, 2b, which can absorb oscillations with adequate mechanical stability.

Sections of the very flexible conductor elements which run in a curved shape, preferably bent through 90°, are in each case formed between the individual connecting terminals and the rigid connection element of the exemplary embodiments. Since a direction change in the profile of a very flexible conductor element in each case runs between two stabilizing clamping-in points, this results in a conductor section with elastic characteristics, which can absorb external oscillation phenomena. Crossing and coincident conductor elements can therefore advantageously support one another.

1-9. (canceled)

10. An electrical switching device arrangement, comprising:
a switching section having at least one first switching point and at least one second switching point;
a conductor section electrically connecting said first and second switching points in series with one another;
said conductor section including at least one first flexible conductor element and at least one second flexible conductor element, said conductor elements having ends attached to contact-making points of said first and second switching points;
wherein a stretched length of said conductor elements is greater than a spacing distance, running along a straight line, between said contact-making points of said first and second switching points; and
a rigid connection element connecting said flexible conductor elements to one another.

11. The electrical switching device arrangement according to claim 10, wherein said rigid connection element is carried by said conductor elements.

12. The electrical switching device arrangement according to claim 10, wherein said rigid connection element is configured to guide said conductor elements parallel to one another.

13. The electrical switching device arrangement according to claim 12, wherein each of said conductor elements is bent through more than 45°, starting from a parallel guidance at said connection element, towards a respective said contact-making point.

14. The electrical switching device arrangement according to claim 12, wherein said conductor elements are bent through more than 90° from said connection element to said contact-making points.

15. The electrical switching device arrangement according to claim 12, wherein said connection element is configured to fix said flexible conductor elements on a plane with respect to one another.

16. The electrical switching device arrangement according to claim 10, wherein at least one of said flexible conductor elements is guided in a U-shape.

17. The electrical switching device arrangement according to claim 10, wherein at least one of said flexible conductor elements is guided in an S-shape.

18. The electrical switching device arrangement according to claim 10, wherein said flexible conductor elements are guided in an equal way and are disposed behind one another, covering one another, on a projection.

19. The electrical switching device arrangement according to claim 10, wherein said flexible conductor elements are arranged with mirror-image symmetry with respect to one another on a projection.

20. The electrical switching device arrangement according to claim 10, wherein said flexible conductor elements are slack electrical cables.
